(19) United States
(12) Patent Application Publication
(10) Pub. No.: US 2022/0350376 A1
(43) Pub. Date: Nov. 3, 2022

(54) DETECT MECHANISM USING ELECTRICAL CONNECTIONS

(71) Applicant: Hewlett-Packard Development Company, L.P., Spring, TX (US)

(72) Inventors: Cheng-Yi Yang, Taipei City (TW); Szu-Tao Tong, Taipei City (TW); Hai-Lung Hung, Taipei City (TW); Chia Ching Lu, Taipei City (TW)

(73) Assignee: Hewlett-Packard Development Company, L.P., Spring, TX (US)

(21) Appl. No.: 17/762,104

(22) PCT Filed: Oct. 18, 2019
(86) PCT No.: PCT/US2019/056935

§ 371 Date: Mar. 21, 2022

(51) Int. Cl. G06F 1/16

(52) U.S. Cl. CPC G06F 1/1694; G06F 1/1637

(57) ABSTRACT

In some examples a computing device can comprise a back plate and an electrical connection. The electrical connection is not in contact with a detect mechanism if a first voltage is generated; and the detect mechanism is in contact with the electrical connection if a second voltage is generated.

### BACKGROUND

A device may include a display unit to display images and data. In some examples, the display can be in a portrait orientation. A “portrait orientation” refers to an orientation of a user interface of the display unit that is taller than it is wide. In some examples, the display can be in a landscape orientation. A “landscape orientation” refers orientation of a user interface of the display unit that is wider than it is tall.

### BRIEF DESCRIPTION OF THE DRAWINGS

FIG. 1 illustrates an example of a computing device with a back plate having a detect mechanism and an electrical connection consistent with the disclosure.

FIG. 2 illustrates an example of a computing device with a back plate without a detect mechanism and an electrical connection consistent with the disclosure,

FIG. 3 illustrates an example of a computing device with a back plate, detect mechanism, and an electrical connection consistent with the disclosure.

FIG. 4 illustrates a block diagram of an example of a controller consistent with the disclosure.

### DETAILED DESCRIPTION

The orientation of a display of a computing device can be oriented in a landscape orientation or a portrait orientation. Such orientations may be useful to display content on a user interface of the display unit to a user. For example, a landscape orientation may be useful for displaying content that is wider than it is tall, and a portrait orientation may be useful for displaying content that is taller than it is wide.

In some examples, a device may use dedicated sensors to determine a display orientation. For example, a system may include gyro and/or other sensors to determine an orientation of a user interface of a display and send control signals over a set of control lines included as graphics circuitry. The graphics circuitry may be designed to request orientation information via the set of control lines. Based on the orientation information received in response to the request, a controller may adjust the orientation of display data transmitted by the graphics circuitry. However, such a device may include expensive sensors.

A detect mechanism using electrical connections, according to the disclosure, can determine a display orientation of a device based on electrical connection with a detect mechanism. In some examples, a detect mechanism can be coupled to a back plate. As described herein, the term “back plate” refers to a component of a rigid structure to house components of a computing device. As described herein, the term “detect mechanism” refers to a conductive material coupled to a backplate of a computing device. The detect mechanism can, in some examples, cause electrical contacts of an electrical connection to be shorted, as is further described herein. As described herein, the term “electric current” refers to the rate of flow of electric charge. As described herein, the term “electrical connection” refers to a direct wire path for electric current to flow between two points in an electric path/circuit. In some examples, the detect mechanism can be a protrusion protruding from the back plate of the computing device. As described herein, the term “protrusion” refers to an object projecting out from the surrounding surface and/or context.

In some examples, an orientation of the back plate can cause a particular voltage to be generated. For example, the back plate can be determined to be in a first orientation if the detect mechanism is not in contact with the electrical connection (e.g., causing a first voltage to be generated). In some examples, the first orientation can be a landscape orientation. When the detect mechanism of the back plate is not in contact with the electrical connection, the electrical connection is not shorted (e.g., resulting in a first voltage being generated), and a user interface of a display is to be oriented in a first orientation (landscape orientation).

In some examples, the back plate can be determined to be in a second orientation if the detect mechanism is in contact with the electrical connection (e.g., causing a second voltage to be generated). In some examples, the second orientation can be a portrait orientation. When the detect mechanism of the back plate is in contact with the electrical connection, the electrical connection is shorted (e.g., resulting in a second voltage being generated), and a user interface of a display is to be oriented in a second orientation (portrait orientation).

In some examples, the orientation of the back plate can cause a particular logic state of the electrical connection to occur. As described herein, the term “logic state” refers to a state that a digital signal can possess, expressed as a DC (direct-current) voltage with respect to electrical ground. In some examples, a positive logic is applied to electric circuits where logic 1 is assigned to the high voltage level. In some examples, a negative logic is applied to electric circuits where logic 0 is assigned to the low voltage level.

In some examples, the detect mechanism is not in contact with the electrical connection, the electrical connection is not shorted (e.g., is open), and a user interface of a display can be oriented in a first orientation (landscape orientation). In some examples, if the detect mechanism is in contact with the electrical connection, the electrical connection is shorted, and the user interface of the display can be oriented in a second orientation (portrait orientation). The orientation of the back plate can cause the logic state of the electrical connection to be high or low, as described herein.

In some examples, if the voltage is above a threshold value the logic state can correspond to a high logic state. In some examples, a display of a device can be displayed in landscape orientation if the logic state is in a high logic state. In some examples, if the voltage is below a threshold value the logic state can correspond to a low logic state. In some examples, a display can be displayed in portrait orientation if the logic state is in a low logic state.

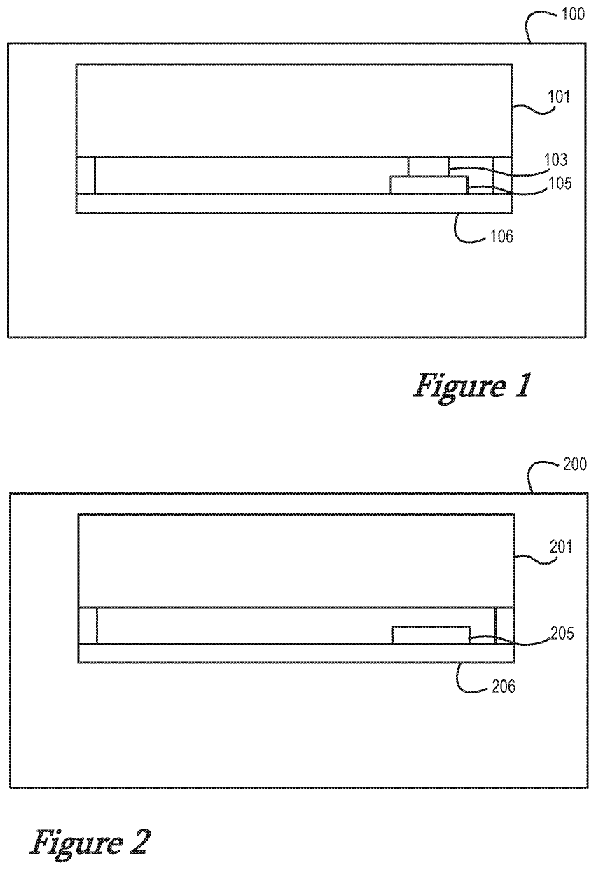

FIG. 1 illustrates an example of a computing device 100 with a back plate 101 having a detect mechanism 103 and an electrical connection 105 consistent with the disclosure. The electrical connection 105 can generate a particular voltage, as is further described herein.

As described herein, the term “voltage” refers to an electromotive force or potential difference. In some examples, the electrical contacts of the electrical connection 105 can be shorted when the detect mechanism 103 is in contact with the electrical connection 105. For example, when the detect mechanism 103 is in contact with the electrical connection 105, an electric current can be created between the electrical contacts of the electrical connection 105, resulting in the electrical contacts being shorted.

The computing device 100 can include a printed circuit board assembly (PCBA) 106. As used herein, the term “PCBA” refers to a board that mechanically supports and electrically connects electronic components or electrical components using conductive tracks, contact pads and/or other features etched from one or more sheet layers of copper laminated onto and/or between sheet layers of a non-conductive substrate. Components can be soldered onto PCBA to both electrically connect and mechanically fasten them to it.

The electrical connection 105 can be part of the PCBA 106 of the computing device 100. In some examples, the back plate 101 can be installed and the detect mechanism 103 can be in contact with the electrical connection 105, as is further described herein.

Electrical connection 105 can include two electrical contacts (not shown in FIG. 1). As described herein, the term “electrical contact” refers to a surface of a metal (e.g., copper) that can provide an electrical path/circuit. In some examples, the detect mechanism 103 can be in contact with the two electrical contacts of the electrical connection 105 and cause a particular voltage to be generated, as is further described herein. In some examples, the two electrical contacts can include a general-purpose input-output (GPIO) contact pad and a ground (GND) contact pad. In some examples, the detect mechanism 103 can be in contact with the GPIO and/or GND pads of the electrical connection 105, as further described herein.

As illustrated in FIG. 1, the computing device 100 can include the detect mechanism 103. The detect mechanism 103 can be a protrusion protruding from the back plate 101 of the computing device 100. In some examples, the detect mechanism 103 can be coupled to the back plate 101 during manufacturing of the back plate 101, In some examples, the detect mechanism 103 can be coupled to the back plate 101 or left off of the back plate 101 (e.g., as is further described in connection with FIG. 2) based on a user preference.

In some examples, the backplate 101 can be attached to the computing device 100 and detect mechanism 103 can contact the electrical connection 105 and the orientation of a display of the computing device 100 can be determined. For example, a user can specify a particular orientation (e.g. a portrait or landscape orientation). Based on the user specification of a portrait orientation, the backplate 101 can include the detect mechanism 103 such that when the backplate 101 is coupled to the computing device 100, the detect mechanism 103 can contact the electric connection 105. The computing device 100 can determine the electrical connection 105 based on the particular voltage generated and orient the display to be in a portrait orientation.

In some examples, the computing device 100 can determine that the detect mechanism 103 is in contact with the electrical connection 105 if a second voltage is generated. For example, the detect mechanism 103 can be in contact with the electrical connection 105 (e.g., the GPIO and/or GND contact pads of the electrical connection 105). When the detect mechanism 103 is in contact with the electrical connection 105, the logic state of the electrical connection 105 can be at a second voltage, such as 0 volts (V). The second voltage can correspond to a low logic state. In some examples, the low logic state value can be at 0 V.

As described above, the computing device 100 can determine that the detect mechanism 103 is in contact with the electrical connection 105 if a second voltage is generated. However, examples of the disclosure are not so limited. For example, the computing device 100 can determine that the detect mechanism 103 is not in contact with the electrical connection 105 if a first voltage is generated, as is further described in connection with FIG. 2.

In some examples, the back plate being oriented in the second orientation can cause an electric current to be generated between the two electrical contacts resulting in a second voltage being generated. For example, if the back plate 101 is in the second orientation, the detect mechanism 103 can be determined to be in contact with the electrical connection 105, the electrical connection 105 can be shorted, and a second voltage can be generated. When back plate 101 is in the second orientation, the logic state can be low.

As illustrated in FIG. 1, the detect mechanism 103 can be oriented in the second orientation (portrait orientation). If the detect mechanism 103 is oriented in the second orientation an electric current between the two electrical contacts can be generated. The connection between the electrical connection 105 and the detect mechanism 103 can determine the orientation of a display of the computing device 100, and the display can be displayed in a portrait orientation.

FIG. 2 illustrates an example of a computing device 200 with a back plate 201 without a detect mechanism and an electrical connection 205 consistent with the disclosure.

In some examples, the electrical connection 205 can be part of a PCBA 206 of the computing device 200. In some examples, the back plate 201 can be installed without a detect mechanism (e.g., 103 as described in relation to FIG. 1) such that there is no detect mechanism in contact with the electrical connection 205.

As illustrated in FIG. 2, computing device 200 can be without a detect mechanism. Since there is not a detect mechanism attached to the back plate 201, there is no contact between a detect mechanism and the electrical connection 205, and the electrical connection 205 can be open. If the electrical connection 205 is open, a first voltage can be generated, and the logic state can be high. If the electrical connection 205 is open, a controller of the computing device 200 can determine the orientation of a display of the computing device 200, as further described herein.

In some examples, a user can specify a particular orientation the user would like the user interface of the display to be oriented. Accordingly, the detect mechanism (e.g., detect mechanism 103, as described in relation to FIG. 1) can be removed or left off of the back plate 201. For example, the user, as described above, can specify to have a landscape orientation for a display of the computing device 201. Based on the user's specification, a controller of the computing device 200 can determine the electrical connection 205 based on a voltage generated that is different from the particular voltage and can orient the display to be in landscape orientation. In some examples, a voltage different from a particular voltage can be a first voltage and a particular voltage can be a second voltage.

In some examples, a controller of the computing device 200 can determine the detect mechanism is not in contact with the electrical connection 205 if a first voltage is generated. When the detect mechanism is not in contact with the electrical connection, the logic state of the electrical connection 205 can be at a first voltage. The first voltage can correspond to a high logic state. For example, a first voltage or a high logic state value can be at or above 3.3 V.

As described above, the orientation of the display of the computing device 200 can be oriented in a landscape orientation based on no detect mechanism 203 being in contact with the electrical connection 205. For example, if there is no detect mechanism 203 in contact with the electrical connection 205 the first voltage can be generated. Based on the first voltage being generated, the back plate 201 can be oriented to the first orientation. In some examples, the first orientation can include a landscape orientation.

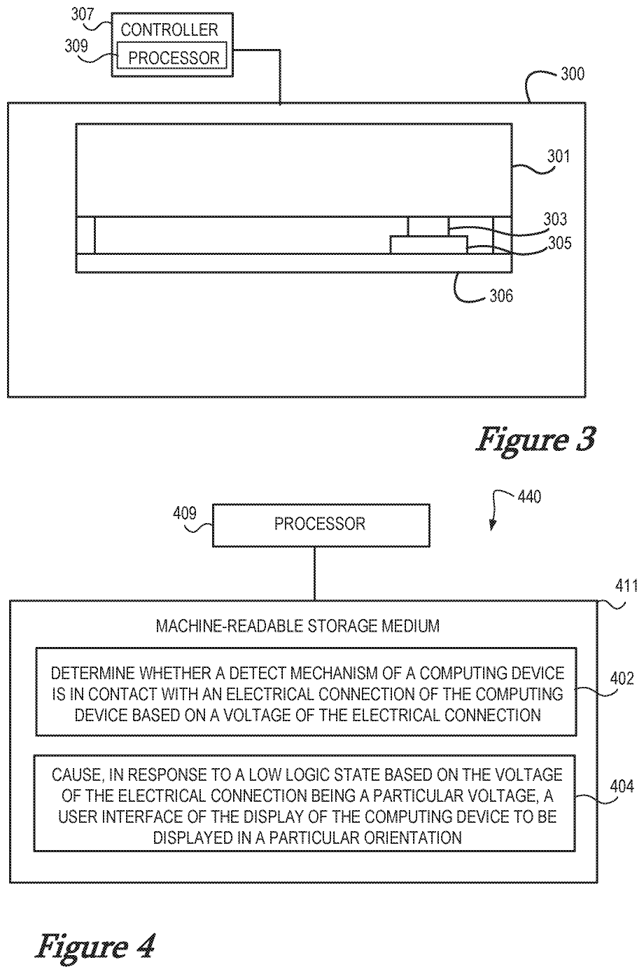

FIG. 3 illustrates an example of a computing device 300 with a back plate 301, detect mechanism 303, and electrical connection 305 consistent with the disclosure. In some examples, the electrical connection 305 can be part of a PCBA 306 of the computing device 300. Computing device 300 can include a controller 307. The controller 307 can be a combination of hardware and/or instructions to cause a user interface of a display to be displayed in a particular orientation based on an electrical connection determination. The hardware, for example, can include a processor 309 and/or a non-transitory machine-readable medium (MRM) (not shown in FIG. 3) communicatively coupled to the processor 309. In some examples, the controller 307 can be an ASIC, FPGA, MPCA, or other combination of circuitry and/or logic to orchestrate execution of instructions described herein.

The processor 309 may include processing circuitry such as a hardware processing unit such as a microprocessor, microcontroller, application specific instruction set processor, coprocessor, network processor, or similar hardware circuitry that may cause machine-readable instructions to be executed. In some examples, the processor 309 may be a plurality of hardware processing units that may cause machine-readable instructions to be executed. The processor 309 may include central processing units (CPUs) among other types of processing units.

Back plate 301, detect mechanism 303, and electrical connection 305 can be analogous to back plate 101, detect mechanism 103, and electrical connection 105, respectively, as described in relation to FIG. 1. The electrical connection 305 can be part of a PCBA of the computing device 300. In some examples, the back plate 301 can be installed and the detect mechanism 303 can be in contact with electrical contacts of the electrical connection 305.

Controller 307 can determine, via a processor such as the processor 309, an orientation of the back plate 301 based on whether the detect mechanism 303 is in contact with the electrical connection 305. The electrical connection 305 can generate a voltage which can be based on whether the back plate 301 includes the detect mechanism 303 and/or whether the detect mechanism 303 is in contact with the electrical connection 305.

In some examples, the back plate 301 can be determined to be in a first orientation if the detect mechanism 303 is not in contact with the electrical connection 305. When the detect mechanism 303 is not in contact with the electrical connection 305, the electrical connection 305 is not shorted, and a user interface of a display can be oriented in a first orientation (e.g., a landscape orientation).

In some examples, the back plate 301 can be determined to be in a second orientation if the detect mechanism 303 is in contact with the electrical connection 305 (e.g., as illustrated in FIG. 3). In some examples, the orientation of the back plate 301 can cause a particular logic state of the electrical connection 305.

Controller 307 can determine, via a processor such as the processor 309, a logic state of the electrical connection 305. When the detect mechanism 303 is in contact with the electrical connection 305, the contact pads of the electrical connection 305 can be shorted, and a user interface of a display can be oriented in a second orientation (e.g., a portrait orientation). The determination of a logic state can be based on whether the detect mechanism 303 is in contact with the electrical connection 305, as is further described herein.

As described herein, electrical connection 305 can include two electrical contacts. In some examples, the backplate 301 may not include a detect mechanism 303 such that there is no contact with the electrical connection 305, causing the electrical connection 305 to be open, and allowing the controller 307 to determine the electrical connection 305 has a high logic state. In some examples, the high logic state can correspond to a first voltage, which can cause a display to be in a landscape orientation.

In some examples, the backplate 301 can include a detect mechanism 303 such that there is contact with the electrical connection 305. When the detect mechanism 303 is in contact with the electrical connection 305, the electrical connection 305 is shorted, allowing the controller 307 to determine the electrical connection 305 has a low logic state. In some examples, the low logic state can correspond to a second voltage which can cause a display to be in a portrait orientation.

Controller 307 can cause, via a processor such as the processor 309, the orientation of the user interface of the display to be displayed in a landscape orientation in response to the logic state being a high logic state. For example, the controller 307 can determine a voltage to be above a threshold value by determining detect mechanism 303 is not in contact with the electrical connection 305. Based on that, the controller 307 can determine the logic state of the electrical connection 307 corresponds to a high logic state. In response to the logic state being in the high logic state, the controller 307 can cause the display of the computing device 300 to be displayed in a landscape orientation.

Controller 307 can cause, via a processor such as the processor 309, the orientation of the display to be displayed in a portrait orientation in response to the logic state being a low logic state. For example, the controller 307 can determine a voltage value to be below a threshold value by determining detect mechanism 303 is in contact with the electrical connection 305. Based on that the detect mechanism 303 being in contact with the electrical connection 305, the controller 307 can determine the logic state of the electrical connection 305 corresponds to a low logic state. In response to the logic state being in the low logic state, the controller 307 can cause the display of the computing device 300 to be displayed in a portrait orientation.

FIG. 4 illustrates a block diagram of an example of a controller 440 consistent with the disclosure. Controller 440 can comprise a processor 409 communicatively coupled to a non-transitory MRM 411 on which instructions may be stored, such as instructions 402 and 404. As used herein, “communicatively coupled” can include coupled via various wired and/or wireless connections between devices such that data can be transferred in various directions between the devices. Although the following descriptions refer to a processor and a memory resource, the descriptions may also apply to a system and/or computing device with multiple processors and multiple memory resources. In such examples, the instructions may be distributed (e.g., stored) across multiple non-transitory MRMs and the instructions may be distributed (e.g., executed by) across multiple processors.

The non-transitory MRM 411 may be electronic, magnetic, optical, or other physical storage device that stores executable instructions. Thus, the non-transitory MRM 411 may be, for example, Random Access memory (RAM), an Electrically-Erasable Programmable ROM (EEPROM), a storage drive, an optical disc, a CDB, and the like. The non-transitory MRM 311 may be disposed within a device, such as a computing device 100 as described in relation to FIG. 1. In this example, the executable instructions 402, and 404, can be “installed” on the device 100. Additionally and/or alternatively, the non-transitory MRM 411 can be a portable, external or remote storage medium, for example, that allows the controller to download the instructions 402 and 404 from the portable/external/remote storage medium. In this situation, the executable instructions may be part of an “installation package”. As described herein, the non-transitory MRM 411 can be encoded with executable instructions for performing various functions described herein.

The controller 440 can be a combination of hardware and/or instructions for a detect mechanism using electrical connections. The hardware, for example, can include the processor 409 and/or the non-transitory MRM 411 communicatively coupled to the processor 409. In some examples, the controller 440 can be an ASIC, FPGA, MPCA, or other combination of circuitry and/or logic to orchestrate execution of instructions 402 and 404. The controller 440 can be analogous to controller 307, described in connection with FIG. 3.

The processor 409 may include processing circuitry such as a hardware processing unit such as a microprocessor, microcontroller, application specific instruction set processor, coprocessor, network processor, or similar hardware circuitry that may cause machine-readable instructions to be executed. In some examples, the processor 409 may be a plurality of hardware processing units that may cause machine-readable instructions to be executed. The processor 409 may include central processing units (CPUs) among other types of processing units.

Instructions 402, when executed by a processor such as the processor 409 can cause the processor 409 to determine whether a detect mechanism of a computing device is in contact with an electrical connection of the computing device based on a voltage of the electrical connection.

The computing device can be analogous to computing device 100 and 300. The computing device can include a back plate and an electrical connection as described in relation to FIG. 1 and FIG. 2, and in some examples, include a detect mechanism.

In some examples, the controller 440 can determine if the detect mechanism is in contact with the electrical connection based on a particular voltage generated. For example, the detect mechanism can be in contact with the electrical contacts (e.g., GPIO and/or GND pads) of the electrical connection. When the detect mechanism is in contact with the electrical contacts, the controller 440 can determine the logic state of the electrical connection to be at a low logic state. In some examples, the low logic state can correspond to a voltage of 0 V.

In some examples, the controller 440 can determine that the detect mechanism of the computing device is not in contact with the electrical connection of the computing device based on a voltage being generated different from the particular voltage. For example, if a first voltage is generated which is different from the particular voltage (e.g., a second voltage), the controller 440 can determine that the detect mechanism is not in contact with the electrical connection of the computing device. In some examples, when there is not a detect mechanism in contact with the electrical contacts, the controller 440 can determine the logic state of the electrical connection to be at a high logic state. In some examples, the high logic state can correspond to a voltage of 3.3 V.

Instructions 404 when executed by a processor such as the processor 409 can cause the processor 409 to, in response to a low logic state based on the voltage of the electrical connection being a particular voltage, cause a user interface of the display of the computing device to be displayed in a particular orientation.

In some examples, the controller 440 can include instructions for the particular orientation to be a portrait orientation. For example, controller 440 can cause the user interface to be displayed in the portrait orientation based on electrical connection (e.g., a short) existing between two electrical contacts of the electrical connection.

In some examples, the controller 440 can cause the user interface to be displayed in a landscape orientation based on the two electrical contacts of the electrical connection not being shorted.

The figures herein follow numbering convention in which the first digit corresponds to the drawing figure number and the digits identify an element or component in the drawing. For example, reference numeral 202 can refer to element 202 in FIG. 2 and an analogous element can be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense.

It can be understood that when an element is referred to as being “on,” “connected to”, “coupled to”, or “coupled with” another element, it can be directly on, connected, or coupled with the other element or intervening elements can be present. In contrast, when an object is “directly coupled to” or “directly coupled with” another element it is understood that are no intervening elements (adhesives, screws, other elements), etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed:

1. A computing device, comprising:
a back plate; and
an electrical connection, wherein:
a detect mechanism is not in contact with the electrical connection if a first voltage is generated; and
the detect mechanism is in contact with the electrical connection if a second voltage is generated.

2. The computing device of claim 1, wherein in response to the first voltage being generated the back plate is oriented in a first orientation.

3. The computing device of claim 2, wherein:
the electrical connection includes two electrical contacts; and
the two electrical contacts are not shorted in response to the back plate being oriented in the first orientation.

4. The computing device of claim 2, wherein the first voltage corresponds to a high logic state.

5. The computing device of claim 1, wherein in response to the second voltage being generated the back plate is oriented in a second orientation.

6. The computing device of claim 5, wherein:
the electrical connection includes two electrical contacts; and
the two electrical contacts are shorted in response to the back plate being in the second orientation.

7. The computing device of claim 5, wherein the second voltage corresponds to a low logic state.

8. A computing device, comprising:
a back plate;
a detect mechanism;
an electrical connection; and
a controller to:
determine an orientation of the back plate based on whether the detect mechanism is in contact with the electrical connection;
determine, based on whether the detect mechanism is in contact with the electrical connection, a logic state of the electrical connection; and
cause a user interface of a display to be displayed in a particular orientation based on the determined logic state of the electrical connection.

9. The computing device of claim 8, wherein the detect mechanism is a protrusion protruding from the back plate of the computing device.

10. The computing device of claim 8, wherein the controller is to:
cause the orientation of the user interface of the display to be displayed in a landscape orientation in response to the logic state being a high logic state; and
cause the orientation of the user interface of the display to be displayed in a portrait orientation in response to the logic state being a low logic state.

11. A controller comprising:
a processor; and
a memory resource storing non-transitory machine-readable instructions to cause the processor to:
determine whether a detect mechanism of a computing device is in contact with an electrical connection of the computing device based on a voltage of the electrical connection;
cause, in response to a low logic state based on the voltage of the electrical connection being a particular voltage, a user interface of the display of the computing device to be displayed in a particular orientation.

12. The controller of claim 11, wherein the particular orientation causes a display to be oriented in is a portrait orientation.

13. The controller of claim 12, wherein the controller is to cause the user interface to be displayed in the portrait orientation based on two contacts of the electrical connection being shorted.

14. The controller of claim 11, wherein the controller is to determine the detect mechanism of the computing device is not in contact with the electrical connection of the computing device based on a voltage being different from the particular voltage.

15. The controller of claim 14, wherein the controller is to cause the user interface to be displayed in a landscape orientation based on two electrical contacts of the electrical connection not being shorted.
